(19) United States
(12) Patent Application Publication
(10) Pub. No.: US 2025/0055240 A1
(43) Pub. Date: Feb. 13, 2025

(54) ADAPTER FOR CONNECTING WIRELESS CONTROLS AND SENSORS TO ELECTRIC DEVICES

(71) Applicant: LEDVANCE LLC, WILMINGTON, MA (US)

(72) Inventors: Anil Jeswani, Acton, MA (US); Deepak Kumar Gedela, Andover, MA (US); Ming Li, Acton, MA (US)

(21) Appl. No.: 18/800,640

(22) Filed: Aug. 12, 2024

Related U.S. Application Data
(60) Provisional application No. 63/519,113, filed on Aug. 11, 2023.

(51) Int. Cl. H01R 31/06; H01R 13/24; H01R 13/623; H01R 13/66; H01R 13/717; H01R 105/00

(52) U.S. Cl. CPC H01R 31/06; H01R 13/2421; H01R 13/623; H01R 13/6683; H01R 13/717; H01R 2105/00

(57) ABSTRACT

An adapter structure comprising an adapter body including an electrical device engagement surface with a first engagement feature for engagement of the adapter body to an electrical device and an adapter engagement surface with a second engagement feature for engagement of at least one of a sensor and wireless controller device to the adapter body. The adapter structure also includes a device electrical interface positioned on the electrical device engagement surface, the device electrical interface including a three pin connector for engaging a three pin receptacle of an electrical device. The adapter structure further includes an adapter electrical interface positioned on the adapter engagement surface, the adapter electrical interface includes a pin connector receptacle for receiving a pin from at least one of the sensor and wireless controller. The pin connector receptacle is in electrical communication with the three pin receptacle.

### CROSS REFERENCE TO RELATED APPLICATION

This patent application is a Continuation and claims benefit and priority to provisional U.S. Patent Application 63/519,113, titled “ADAPTER FOR CONNECTING WIRELESS CONTROLS AND SENSORS TO ELECTRIC DEVICES” filed on Aug. 11, 2023, which is herein incorporated by reference in its entirety

### TECHNICAL FIELD

The present disclosure generally relates to lighting structure, and more particularly device structures for engaging wireless communication modules to lighting structures.

### BACKGROUND

Home and professional environments can contain many controllable electrical devices for controlling the ambient environment. For example, lightings structures are employed for the creation of ambient, atmosphere, accent or task lighting. The controllable electrical devices are often connected and controlled via a wireless network. These electrical devices can be controlled individually or in groups via a user interface of a lighting control. However, in some instances, the means by which wireless communication is brought to the electrical devices may change. For example, standards in electrical interfaces for connecting electrical devices to wireless control devices can change as technology progresses.

### SUMMARY

The present disclosure provides apparatuses, systems and methods that employ an adapter structure for connecting an existing electrical interface of an electrical device to a different electrical interface of a wireless control module, in which the wireless control module can provide both a sensor and control device to the electrical device through the adapter.

In one aspect, the present disclosure provides an adapter for mating a first electrical interface of an electrical device to a second electrical interface of a wireless control module, in which the first and second electrical interfaces are different. In one embodiment, the adapter structure includes an adapter body having an electrical device engagement surface with a first engagement feature for engagement of the adapter body to an electrical device and an adapter engagement surface with a second engagement feature for engagement of at least one of a sensor and wireless controller device to the adapter body. The adapter structure also includes a device electrical interface positioned on the electrical device engagement surface. The device electrical interface can includes three pin connector for engaging a three pin receptacle of an electrical device. The adapter structure may further include an adapter electrical interface positioned on the adapter engagement surface. The adapter electrical interface includes a pin connector receptacle for receiving a pin from at least one of the sensor and wireless controller. The pin connector receptacle is in electrical communication with the three pin connector.

In another aspect of the present disclosure, a system for controlling lighting is provided, in which an adapter is included for mating a first electrical interface of an electrical device to a second electrical interface of a wireless control module, in which the first and second electrical interfaces are different. In one embodiment, the system includes an electrical device that includes at least one light engine comprising light emitting diodes (LEDs). The at least one light engine is powered by an electronics driver in electrical communication with a three pin receptacle through which electrical signal to the electronics driver is communicated. The system can also include a wireless communication device that includes at least one of a controller and a sensor. The wireless communication device includes a pin connector interface for transmitting at least one of data and control signals. The system can also include an adapter that includes an adapter body including an electrical device engagement surface with device electrical interface including a three pin connector for engaging a three pin receptacle of the electrical device. The adapter of the system can include a wireless communication device engagement surface including a pin connector receptacle for receiving the pin connector interface of the wireless communication device. The pin connector receptacle of the adapter is in electrical communication with the three pin connector of the adapter.

In yet another aspect, a method of converting an electrical device to a wirelessly controlled device is described. In one embodiment, the method can include configuring an electrical device including at least one light engine comprising light emitting diodes to expose a three pin receptacle through which electrical signal is sent to an electronics driver that is in electrical communication with the at least one light engine. The method can further include engaging an adapter to the electrical device. The adapter can include an adapter body including an electrical device interface including a three pin connector. The three pin connector of the adapter is for engaging the three pin receptacle of the electrical device. The adapter also includes a pin connector receptacle that is in electrical communication with the three pin connector. The method may continue with engaging the wireless communication device including the at least one of a controller and a sensor to the adapter. The wireless communication device includes a pin connector interface for transmitting at least one of data and control signals that engages the pin connector receptacle of the adapter.

### BRIEF DESCRIPTION OF THE DRAWINGS

The following description will provide details of embodiments with reference to the following figures wherein:

FIG. 1 is an illustration of a system for controlling lighting including an adapter for mating a first electrical interface of an electrical device to a second electrical interface of a wireless control module, in which the first and second electrical interfaces are different, in accordance with one embodiment of the present disclosure.

FIG. 2 is a perspective view of a UFO highbay light fixture, which is one example of an electrical device that can be used with the adapter apparatus and method described with reference to FIG. 1.

FIG. 3 is a perspective view of a linear highbay light fixture, which is another example of an electrical device that can be used with the adapter apparatus and method described with reference to FIG. 1.

FIG. 4 is a perspective view of a high intensity discharge (HIDr) retrofit light, which is another example of an electrical device that can be used with the adapter apparatus and method described with reference to FIG. 1.

FIG. 5 is a perspective view of one embodiment of a 3.5 mm Pin Smart Sensor/Controller, which is one example can provide the wireless control module for the apparatus, systems and methods described in FIG. 1.

FIG. 6 is a perspective view of one embodiment of a 3.5 mm pin PIR sensor.

### DETAILED DESCRIPTION

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

The apparatus, system and methods described herein enable a field-installable sensor adapter design that enables a customer to easily install either non-smart sensors or smart sensors on luminaires, which have a three pin receptable. This provides more options to the customers, helps to reduce costs and improves logistics.

A “luminaire” is a complete lighting unit comprising of a light source(s) and ballast(s) or driver(s) (when applicable), together with the parts designed to distribute the light, to position and protect the light source(s), and to connect the light source(s) to the power supply. Also known as a light fixture. The luminaires described herein employ a solid state light source, such as light emitting diodes (LEDs). The term “solid state” refers to light emitted by solid-state electroluminescence, as opposed to incandescent bulbs (which use thermal radiation) or fluorescent tubes, which use a low pressure Hg discharge. Compared to incandescent lighting, solid state lighting creates visible light with reduced heat generation and less energy dissipation. Some examples of solid state light emitters that are suitable for the methods and structures described herein include inorganic semiconductor light-emitting diodes (LEDs), organic light-emitting diodes (OLED), polymer light-emitting diodes (PLED) or combinations thereof. Although the following description describes an embodiment in which the solid-state light emitters are provided by light emitting diodes, any of the aforementioned solid-state light emitters may be substituted for the LEDs. As used herein, “light emitting diode (LED)” and “light emitting semiconductor structure” refer to a stack of semiconductor layers, including an active region which emits light when biased to produce an electrical current flow through the device, and contacts attached to the stack.

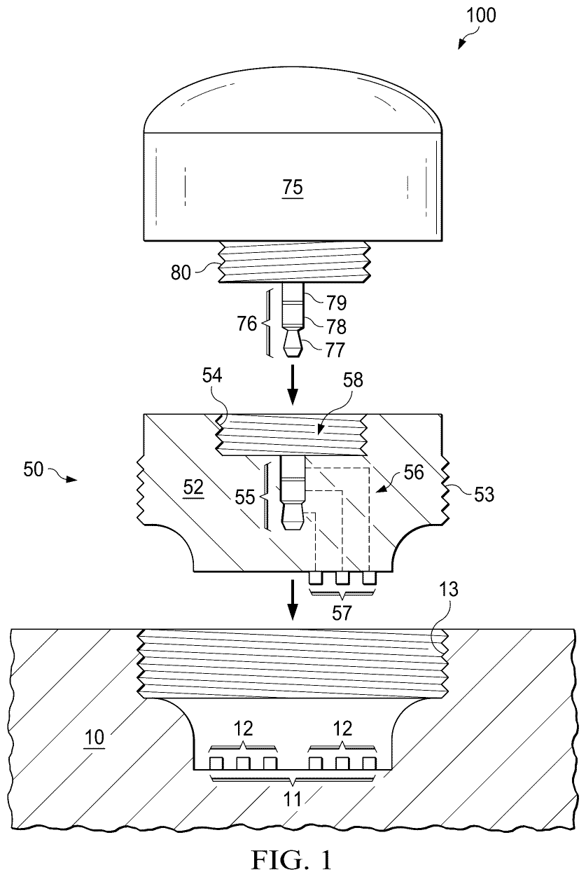

FIG. 1 is an illustration of a system 100 for controlling lighting including an adapter 50 for mating a first electrical interface 11 of an electrical device 10 to a second electrical interface 76 of a wireless control module 75, in which the first and second electrical interfaces 11, 76 are different. In one embodiment, the system 100 may include a smart sensor/controller, e.g., Bluetooth wireless control, with a 3.5 mm pin plug and play interface, which may be referred to as a wireless control module 75. In one embodiment, the wireless control module 75 is field installable to a 3-pin to 3.5 mm pin sensor adapter, which may be referred to adapter structure 50. In one embodiment, adapter structure 50 may be installed into a 3-pin receptacle on an electrical device 10, e.g., a luminaire with factory installed 3-pin sensor receptacle that can accept a sensor, such as a non-smart sensor.

For example, the first electrical interface 11 may include a target 12 (also referred to as land) of electrically conductive features for engagement to a three (3) pin pogo connector 51 in electrical communication. A 3-pin Pogo Connector 51 is assembled by pogo pins and a housing of 3 pins. A pogo pin or spring-loaded pin is a type of electrical connector mechanism that may be used for their durability over other electrical contacts, and the resilience of their electrical connection to mechanical shock and vibration. The name “pogo pin” comes from the pin's resemblance to a pogo stick, which in some embodiments can include an integrated helical spring in the pin applies a constant normal force against the back of the mating receptacle or contact plate, counteracting any unwanted movement which might otherwise cause an intermittent connection.

In some embodiments, the pogo pin, e.g., spring loaded pin, may include 3 main parts: a plunger, barrel, and spring. When force is applied to the pin, the spring is compressed and the plunger moves inside the barrel. The shape of the barrel retains the plunger, stopping the spring from pushing it out when the pin is not locked in place. The plunger and barrel of pogo pins usually use brass or copper as a base material on which a thin layer of nickel is applied. In some examples, a gold plating that improves the durability and contact resistance. The springs can be made of copper alloys or spring steel.

A complete connection path includes a mating receptacle for the pin to engage, which is termed a “target” or “land”. In the embodiment that is depicted in FIG. 1, the pogo pins of the three (3) pin pogo connector 51 are positioned on the adapter 50, i.e., the base surface of the adapter body 52. The three (3) pin pogo connector 51 at the base of the adapter body 52 may provide the device electrical interface for the adapter 50. The “target” or “land” that the three (3) pin pogo connector 51 contacts is present on the electrical device 10. More particularly, the “target” or “land” is a three pin receptacle of the electrical device 10. In one embodiment, the target 12 includes three concentric electrical tracks corresponding to the three (3) pin pogo connector 51. The circular geometry of the tracks for the target 12 enable the three pins to maintain contact to the tracks as the adapter is rotated to engage the screwed engagement of the adapter 50 to the electrical device 50, as described in greater detail below. A pogo target 12 may include a flat or concave metal surface, which unlike the pins, has no moving parts.

Both the pogo pins of the three (3) pin pogo connector 51 that is present on the adapter body 52 and the target 12 of the electrical device 10 are composed of an electrically conductive material, such as a metal, e.g., copper or aluminum. The pogo pins of the three (3) pin pogo connector 51 come in direct contact with the target 12 of the electrical device 10 when the adapter 50 is engaged to the electrical device 10. This provides that the three (3) pin pogo connector 51 and the target 12 are in wireline communication. Wireline communication (also known as wired communication) is the transmission of information over a physical filament.

Still referring to FIG. 1, while the electrical device 10 may include the first electrical interface 11 of a three pin receptacle 12 for the transmission of control and data signals to the electrical device 10; the wireless control module 75 includes a second electrical interface 76 that is different in geometry from the first electrical interface 11. For example, the second electrical interface 76 of the wireless control module 75 may include a single pin. For example, the single pin may be a 3.5 mm jack. It is noted that this is only one example of pin for the second electrical interface 76. The pin is characterized by its' diameter. For example, a 3.5 mm pin is a pin having a diameter of 3.5 mm. Further, although some examples of the second electrical interface may include a pin having a 3.5 mm diameter, it is not intended that the present disclosure be limited to only 3.5 mm diameter pins for the second electrical interface 76. For example, the pin for the second electrical interface may also have diameters equal to 2.0 mm, 2.5 mm and 6.32 mm.

It is noted that the pin may have a plurality of conductors or poles depending upon the configuration of the pin. For example, a tip-sleeve (TS) configuration pin may include two (2) conductors or poles. In another example, a tip-ring-sleeve (TRS) configuration pin may include three (3) conductors or poles. It is noted that in the example depicted in FIG. 1, the pin that provides the second electrical interface 76 is a tip-ring-sleeve (TRS) configuration pin, in which each of the tip (T) 77, the ring (R) 78, and the sleeve (S) 79 are individual conductors that are in electrical communication with each of the individual pins of the three (3) pin pogo connector 51. In yet another example, the pin for the second electrical interface 76 of the wireless control module 75 may include four conductors or poles. A pin configured in this manner may be a pin having a tip (T), ring (R), ring (R), sleeve (S) configuration. In yet another embodiment, the pin may have a tip (T), ring (R), ring (R), ring (R), sleeve (S) configuration, which would provide five conductors or poles. It is noted that the above description only provides some embodiments of the pin for the second electrical interface 76 of the wireless control module 75.

As indicated by the above description, the first electrical interface 11 of the electrical device 10 has as different geometry from the second electrical interface 75 of the wireless control module 75. For example, the first electrical interface 11 of the electrical device 10 may be a three pin receptacle 12, and the second electrical interface 76 may be a single 3.5 mm pin that provides a plug and play interface for a Bluetooth wireless controller.

Still referring to FIG. 1, the present disclosure provides an adapter 50 that provides for communication between the first electrical interface 11 of the electrical device 10 and the second electrical interface 76 of the wireless control module 75. In one embodiment, the adapter structure 50 includes an adapter body 52 having an electrical device engagement surface with a first engagement feature 53 for engagement of the adapter body 52 to an electrical device 10 and an adapter engagement surface with a second engagement feature 54 for engagement of at least one of a sensor and wireless controller device 75 (also referred to as wireless control module) to the adapter body 52.

The adapter structure 50 also includes a device electrical interface, e.g., provided by a three (3) pin pogo connector 51, positioned on the electrical device engagement surface. The device electrical interface can includes three pin connector 51 for engaging a three pin receptacle 12 of an electrical device 10. The adapter structure 40 may further include an adapter electrical interface 55 positioned on the adapter engagement surface. The adapter electrical interface includes a pin connector receptacle 55 for receiving a pin 76 from at least one of the sensor and wireless controller device 75.

In one embodiment, the pin connector receptacle 55 is in electrical communication with the device electrical interface, e.g., provided by a three (3) pin pogo connector 51. For examples, filaments 56 may extend from the pogo pins of the three (3) pin pogo connector 51 through the adapter body 52 to contacts positioned within the pin connector receptacle 55 and arranged within the pin connector receptacle 55 to correspond with the contacts and/or poles of the pin. For example, the filaments 56 may be configured to provide for electrical communication between the second electrical interface 76 having the tip-ring-sleeve (TRS) configuration pin, in which each of the tip (T) 77, the ring (R) 78, and the sleeve (S) 79 are individual conductors that are in electrical communication with each of the individual pins of the three (3) pin pogo connector 51, as illustrated in FIG. 1.

Turning to the engagement of the adapter structure 50 to the electrical device 10, the electrical device 10 may have a recess, e.g., luminaire receptacle, in its external housing for housing at least a portion of the adapter structure. For example, the adapter structure 50 may have standard threads on the side of the component at its exterior perimeter dimension, e.g., thread sizes in accordance with standard DIN 6063-1 (e.g., thread sizes KS 10-KS 60) and DIN 6063-2 (e.g., thread sizes KT 10-KT 50).

These thread features are employed to engage the adapter inside the electrical device, e.g., within a luminaire receptacle, by aligning and rotating until the adapter housing 52 fully engages the receptacle of the electrical device. In one embodiment, the first engagement feature 53 of the adapter structure 50 is a male threaded structure for engagement of a female threaded structure 13 of the electrical device 10. In this example, a screw thread of the male threaded structure that provides the first engagement feature 53 engages the internal thread of the female threaded structure 13 for the electrical device 10.

In some embodiments, the adapter structure 50 has 3 pins, e.g., pogo pins from a three (3) pin pogo connector 51, at the bottom, i.e., base of the adapter structure 50. The 3 pins, e.g., pogo pins from a three (3) pin pogo connector 51, at the bottom, i.e., base of the adapter structure 50 provide electrical communication from the three pin receptacle 12 of an electrical device 10 to the sensor, e.g., at least one of a sensor and wireless controller device 75 (also referred to as wireless control module), that is installed into the opposing side of the adapter structure 50. More particularly, the side of the adapter structure 50 opposite the base of the adapter structure that the three (3) pin pogo connector 51 is positioned on has an opening 58 present therein that provide the adapter engagement surface, in which the opening to the adapter engagement surface has an internal adapter electrical interface 55 positioned therein.

In this example, as the adapter structure 50 and/or the electrical device 10 are rotated to thread the screw thread of the male threaded structure that provides the first engagement feature 53 into threaded engagement with the internal thread of the female threaded structure 13 for the electrical device 10, electrical communication between the pogo pins of the device electrical interface, e.g., provided by a three (3) pin pogo connector 51, positioned on the electrical device engagement surface of the adapter structure 50, and the first electrical interface 11 of the electrical device 10 provided by the three pin receptacle 12 is maintained. This is because the three pin receptacle 12 includes three circular targets having diameters configured to correspond to the spacing of the pogo pins of the three (3) pin pogo connector 51, as the adapter structure 50 is rotated about its central axis.

In some examples, the adapter structure 20 has three pin connectors of pogo pins. The individual pogo pins for the three pin connector 51 are spaced to engage a target that provides the three pin receptacle 12 of the electrical device 10. In some examples, the target has a geometry of a circle for each pogo pin, wherein the pins contact the geometry of the circle for the target as the adapter body 52 is engaged to the electrical device 10 by rotating the adapter body 52 relative to the device 10 to thread the male threaded male engagement structure for the adapter body to the female threaded structure of the electrical device. This provides engagement of the adapter structure 50 to the electrical device 10.

Turning to the engagement of the wireless control module 75 (also referred to as least one of a sensor and wireless controller device 75) to the adapter structure 50, the adapter body 52 may include an adapter engagement surface with a second engagement feature 54 for engagement of at least one of a sensor and wireless controller device 75 to the adapter body 52. The portion of the adapter body 52 for engaging the wireless control module 75 (also referred to as least one of a sensor and wireless controller device 75) may be at the top and middle of the adapter body 52, which in some examples can include a 3.5 mm pin receptacle. The inside middle portion (also referred to as opening 58) has a recess with standard threads to provide a second engagement feature 54 that retains the wireless control module 75 (also referred to as least one of a sensor and wireless controller device 75). For example, the adapter structure 50 may have standard thread sizes for the second engagement feature 54 in accordance with standard DIN 6063-1 (e.g., thread sizes KS 10-KS 60) and DIN 6063-2 (e.g., thread sizes KT 10-KT 50).

In some embodiments, the second engagement feature 54 for the adapter body 52 is a female threaded structure for engagement of a male threaded structure of the as least one of a sensor and wireless controller device 75 (also referred to a wireless controller device 75). The side of the adapter structure 50 that interfaces with the wireless control module 75 (also referred to at least one of a sensor and wireless controller device 75) is on the opposite side of the adapters structure 50 from the side that interfaces with the electrical device 10. More particularly, the side of the adapter structure 50 is opposite the base of the adapter structure that the three (3) pin pogo connector 51. The side of the adapter body 52 that engages the wireless control module 75 (also referred to at least one of a sensor and wireless controller device 75) has an opening 58 present therein that provide the adapter engagement surface, in which the opening to the adapter engagement surface has an internal adapter electrical interface 55 positioned therein. The sidewalls of the opening 58 provide the location of the second engagement feature 54 for the adapter body 52, which is a female threaded structure for engagement of a male threaded structure 80 of the at least one of a sensor and wireless controller device 75 (also referred to a wireless controller device 75). More particularly, in some embodiments, an internal thread of the female threaded structure that provides the second engagement feature 54 engages the screw thread of the male threaded structure 80 for the sensor 75.

In some embodiments, by employing the aforementioned threaded structures, e.g., second engagement feature 54 (female threaded) and a male threaded structure 80, the at least one of a sensor and wireless controller device 75 (also referred to a wireless controller device 75) may be engaged to the adapter structure 50. Engagement of the at least one of a sensor and wireless controller device 75 and the adapter structure 50 may include inserting the pin 76 from at least one of the sensor and wireless controller 75 into the pin connector receptacle 55 of the adapter structure 50, and rotating the at least one of a sensor and wireless controller device 75 relative to the adapter structure 50 to thread the male threaded male engagement structure, i.e., second engagement feature 54, for the adapter body 52 to the female threaded structure 54 of the adapter body 52.

Still referring to FIG. 1, the adapter structure 50 includes an adapter electrical interface positioned on the adapter engagement surface, the adapter electrical interface includes a pin connector receptacle 55 for receiving a pin 76 from at least one of the sensor and wireless controller 75. The pin connector receptacle 55 of the adapter body 52 is in electrical communication with the three (3) pin pogo connector 51.

Referring to FIG. 1, the adapter structure 50 further includes filament paths 56 through the adapter body 52 bringing electrical communication from the three (3) pin pogo connector 51 (device electrical interface) positioned on the electrical device engagement surface of the adapter body 52 to the adapter electrical interface including the pin connector receptacle 55 for receiving a pin 76 from at least one of the sensor and wireless controller device 75. The filament paths 56 are an electrically conductive structure that extends through the insulating material of the adapter body 52, which may be a polymeric plastic material. In some examples, the filament paths 56 may be wires. Each filament path 56 extends from a single pogo pin of the three (3) pin pogo connector 51 (device electrical interface) to a portion of the pin connector receptacle 55 providing the second electrical interface 76 that contacts a single contact or pole in the tip-ring-sleeve (TRS) configuration pin.

It is noted that the threaded configuration for the first and second engagement features 53, 54 are only one embodiment of the present disclosure, and it is not intended that the present disclosure be limited to only this example. For example, other embodiments have been contemplated for engagement of the adapter body 52 to the electrical device 10. For example, the engagement of the adapter structure 50 to the electrical device 10 may be provided using twist lock connectors, e.g., quart twist lock connectors, snap fit engagement and/or magnetized retention. In one example, the engagement features of the adapter structure 50 can include a deformable tab having a retaining edge for reversible engagement into the a slot of the electrical device 10.

Additionally, other embodiments have been contemplated for engagement of the at least one of a sensor and wireless controller device 75 (also referred to a wireless controller device 75) to the adapter body 52. For example, engagement of the at least one of a sensor and wireless controller device 75 (also referred to a wireless controller device 75) to the adapter structure 50 may be provided using twist lock connectors, e.g., quart twist lock connectors, snap fit engagement and/or magnetized retention. In one example, the engagement features of the at least one of a sensor and wireless controller device 75 (also referred to a wireless controller device 75) can include a deformable tab having a retaining edge for reversible engagement into the a slot of the adapter structure 50.

It is further noted that the electrical interfaces described for adapter structure 50, the electrical device 10 and the at least one of a sensor and wireless controller device 75 (also referred to a wireless controller device 75) have also been provided for illustrative purposes, and other interfaces have also been contemplated, and are within the scope of the present disclosure.

For example, it is not required that the connectors for input to the electrical device 10 include a three pin arrangement, as depicted for the three (3) pin pogo connector 51. Two pin arrangements, four pin arrangements, and pin arrangements using more than four pins are also within the scope of the present disclosure. The number of pins may be dependent upon the type of signal transmission and the type of data being transmitted by the signal transmission to the electrical device 10. Additionally, the profiles of the pins may be modified. The pins may be round or have other profile shapes. There are options for spring loaded structures.

In another example, it is not required that the connectors for output to the at least one of a sensor and wireless controller device 75 (also referred to a wireless controller device 75) include a 3.5 mm pin (or other similar type dimension pin/jack), as depicted for the second electrical interface 76 of the wireless control module 75. For example, interfaces such as USB-C, and micro-USB may substituted for the 3.5 mm pin of the second electrical interface 76, and the adapter structure 50 may be modified to have a corresponding port.

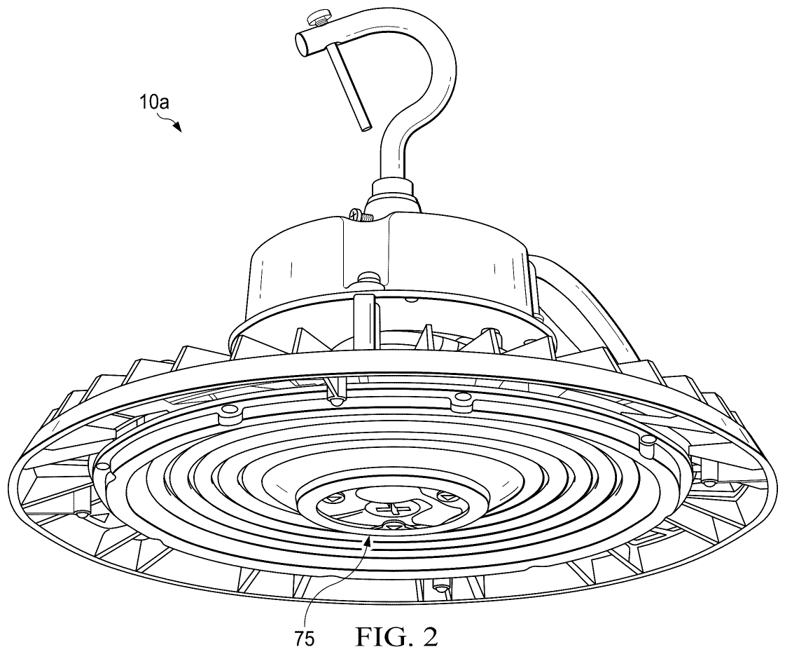

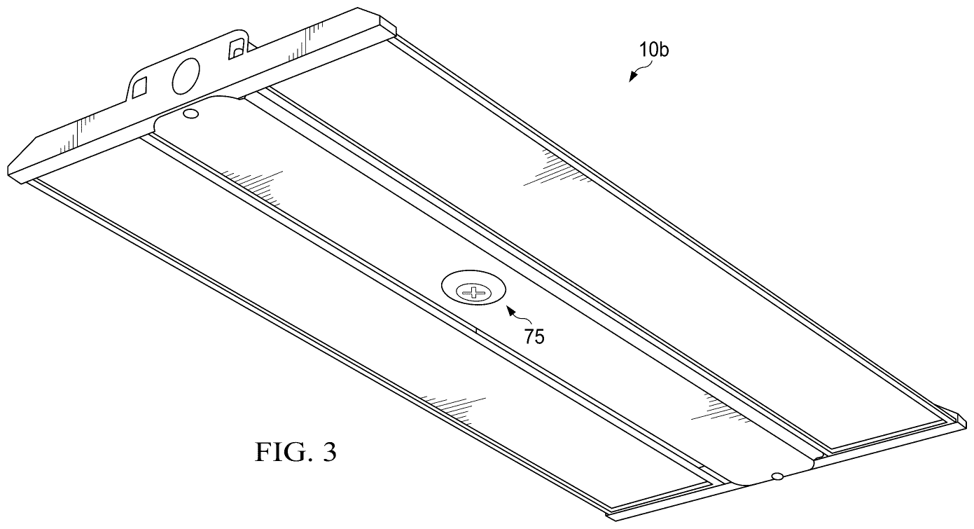

The adapter structure 50 depicted in FIG. 1 may be integrated into a wirelessly controlled device system including the electrical device 10, the adapter structure 50, and the wireless communication device 75 (also referred to as an at least one of a sensor and wireless controller device 75 or wireless controller device 75). The electrical device 10 may be a luminaire. The luminaire 10a, 10b may be have a high bay form factor, as depicted in FIGS. 2 and 3. A “bay light” illuminates a large area with a high ceiling. Application examples include warehouses, commercial buildings, retail locations, and gymnasiums. There are two categories: high and low bay light fixtures. The primary characteristic used to tell them apart is ceiling height, but they have other similarities and differences. High and low bay lighting fixtures are both used to illuminate large areas and mounted onto high ceilings to provide stronger light while reducing glare. Ceiling height is the best way to compare high bay vs. low bay lighting. Low bay fixtures generally work with ceilings that are between 12-20 feet high. High bay light fixtures can illuminate ceilings that are 20-45 feet high. The lightings also differ in strength. In some embodiments, low bay lighting is below 100 watts while high bay lighting can go above 100 watts.

The lighting fixtures use different hanging methods. Low bay lighting is generally suspension mounted with chains or hooks. High bay lighting can hang from the ceiling using a hook, chain, or pendant or fixed to the ceiling directly like a troffer light.

Light emitting diodes (LEDs) can serve as the light source, e.g., light engine component, suitable for high bay applications, as well as low bay lighting.

The use of light emitting diodes in bay lighting allows for a luminaire geometry that may be rectangular or in a strip shape, wherein the lights are arranged in a linear shape that increases coverage and uniformity of the area to be illuminated. LED technology allows for high bay light installation in non-round shapes, such as linear and grid mounted. A liner high bay luminaire 10b is illustrated in FIG. 3, which may serve as one example of an electrical device 10 through which the adapter structure 50 provides for engagement of a wireless communication device 75 (also referred to as an at least one of a sensor and wireless controller device 75 or wireless controller device 75) in which the electrical interfaces for the electrical device 10 and the wireless communication device 75 (also referred to as an at least one of a sensor and wireless controller device 75 or wireless controller device 75) are different.

However, the round shape continues to be an option in areas where high bay lights are required. FIG. 2 illustrates one embodiment of a UFO LED high bay light (luminaire 10a). A UFO LED high bay light is a UFO disc-shaped LED luminaire system which can feature a flat integral aluminum housing with optics specifically configured to optimize the light distribution over a given area without relying on bulky reflectors. In some instances LEDs are directional in nature and can require optics, which is usually reflectors for LED high bay lights, in order to meet the light output patterns necessary for many applications. However, conventional fixtures typically mimic traditional metal-halide (MH) fixtures in luminaire shape and furthermore designed with bulky and heavy heat sinks. The entire fixture not only looks outdated and clumsy, but also does not match well with contemporary architectural design. UFO LED high bay lights are more compact and efficient than the traditional LED fixtures.

The circular geometry high bay light, e.g., UFO LED high bay light, illustrated in FIG. 2 can serve as one example of an electrical device 10 through which the adapter structure 50 provides for engagement of a wireless communication device 75 (also referred to as an at least one of a sensor and wireless controller device 75 or wireless controller device 75) in which the electrical interfaces for the electrical device 10 and the wireless communication device 75 (also referred to as an at least one of a sensor and wireless controller device 75 or wireless controller device 75) are different.

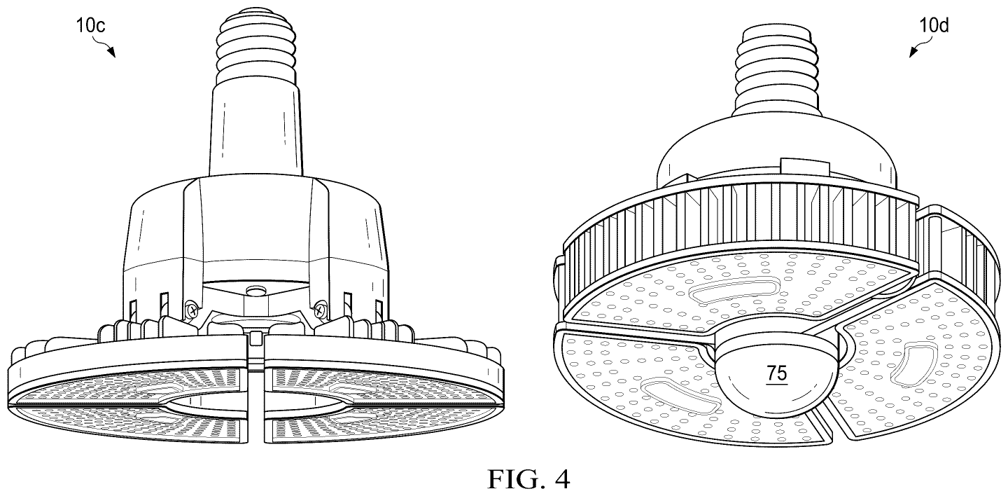

FIG. 4 illustrates yet another example of a luminaire 10c, 10d that can be employed with the adapter structure 50 described with reference to FIG. 1. The luminaire 10c, 10d depicted in FIG. 4 may be a HIDr lamp. A “high intensity discharge replacement” lamp is an HID replacement lamps that replaces the high intensity discharge lighting elements with light emitting diodes, and are ideal for indoor high/low bay lighting and outdoor decorative post top fixtures in walkway lighting applications. The lumen and CCT selectable option allows for customizable light output in HIDr lamps as depicted in FIG. 4 replacing up to 400 W HID applications. The HIDr lamp includes a screw electrode for engagement to a lamp holder that is in electrical communication with a main power source.

It is noted that the above examples are provided for illustrative purposes only. It is not intended that the form factor be limited to only the above provided examples. Other examples have been contemplated for use with the adapter structure 50 described herein, such as recessed can down lights, and light figures using tube lamp arrangements, each employing light emitting diodes for the light source. In some embodiments, all that is required of the luminaire, such as a luminaire, e.g., the luminaires 10a, 10b, 10c, 10d illustrated in FIGS. 2-4, to serve as an electrical device 10 consistent with the description in FIG. 1 is that the at least one light engine for the luminaire is powered by an electronics driver that are in electrical communication with a three pin receptacle 12 (as described with reference to FIG. 1) through which electrical signal to the electronics driver is communicated. That electrical signal is used to control lighting characteristics of the luminaire 10a, 10b, 10c, 10d (which is an example of an electrical device 10 described in FIG. 1). In the embodiments illustrated in FIGS. 2-4, the three pin receptacle 12 is positioned in a centrally located position within an array of light emitting diodes (LEDs) providing the light source for the luminaire 10a, 10b, 10c, 10d.

The adapter structure 50 depicted in FIG. 1 may be integrated into a wirelessly controlled device system also including the wireless communication device 75 (also referred to as an at least one of a sensor and wireless controller device 75 or wireless controller device 75). In one embodiment, the at least one of the sensor and wireless controller 75 is a bluetooth mesh device. Bluetooth Mesh is a computer mesh networking standard based on Bluetooth Low Energy that allows for many-to-many communication over Bluetooth radio. The Bluetooth Mesh specifications were defined in the Mesh Profile and Mesh Model specifications by the Bluetooth Special Interest Group (Bluetooth SIG). Bluetooth mesh communication is an example of transmitting information over-the-air (OTA), and may be referred to as wireless.

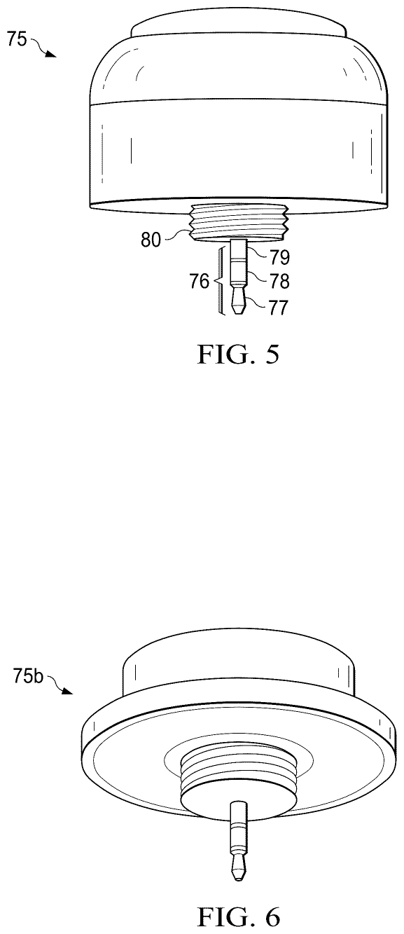

In one embodiment, the wireless communication device 75 (also referred to as an at least one of a sensor and wireless controller device 75 or wireless controller device 75) may be a 3.5 mm pin bluetooth mesh low voltage sensor and controller, as depicted in FIG. 5. In some embodiments, the 3.5 mm pin bluetooth mesh low voltage sensor and controller can be easily added to luminaire using a side adapter in the luminaire housing, and can installs in a ½″ knockout of the luminaire so long as the wireless communication device 75 can engage the adapter structure 50, which has been fitted to the electrical device 10, e.g., luminaire, as described with reference to FIG. 1.

Referring to FIG. 5, the 3.5 mm pin bluetooth mesh low voltage sensor and controller can be commissioned and sensor options can be selected for light characteristics, operations, and scheduling features through an application run on a mobile computing device that provides a user interface, such as a smart phone. It is noted that a smart phone is not the only computing device through which a user can communicate with the wireless communication device 75 to control the electrical device, e.g., luminaire, e.g., for commissioning and/or operation. Other user terminal options may include a computing device selected from the group consisting of a table computer, laptop computer, desktop computer, computing terminal and combinations thereof.

Additionally, the 3.5 mm pin bluetooth mesh low voltage sensor and controller can be commissioned and sensor options can be selected for light characteristics, operations, and scheduling features through a wall switch, such as a multi-button Bluetooth mesh wireless wall switch providing control of the luminaires and sensors via communication with the wireless communication device 75 (also referred to as an at least one of a sensor and wireless controller device 75 or wireless controller device 75) that is in electrical communication with the electrical device through the adapter structure 50, as described with reference to FIG. 1. In some examples, the wall switch can turn the lights on/off, dim up/down, choose between preset scenes (up to 3 scenes) and turn the Auto mode (sensor) on/off. The wall switch may be Bluetooth Mesh enabled.

Referring back to FIG. 5, the 3.5 mm pin bluetooth mesh low voltage sensor and controller that provides the wireless communication device 75 (also referred to as an at least one of a sensor and wireless controller device 75 or wireless controller device 75) can be employed to commission and configure luminaires using an application that sends commands to the electrical device 10 that is in communication with the 3.5 mm pin bluetooth mesh low voltage sensor and controller through the adapter structure 50, as described in FIG. 1.

For example, the 3.5 mm pin bluetooth mesh low voltage sensor and controller that provides the wireless communication device 75 (also referred to as an at least one of a sensor and wireless controller device 75 or wireless controller device 75) can enable regular luminaires to become Bluetooth enabled and allows for luminaires to be turned on/off, dimmed (manual or auto), and respond to the daylight and motion sensor.

In some examples, the 3.5 mm pin bluetooth mesh low voltage sensor and controller is linkable with Bluetooth Mesh Line Voltage Controller.

In some examples, the 3.5 mm pin bluetooth mesh low voltage sensor and controller when used in combination with control applications run on mobile devices, e.g., smart phones, can provides for wireless communication to the electrical devices 10, e.g., luminaires, through the adapter structure 50, which allows for configuring and commissioning the electrical devices, e.g., luminaires, for grouping and zoning, i.e., wirelessly configuring luminaires to act in sync with each other.

In other examples, the 3.5 mm pin bluetooth mesh low voltage sensor and controller when used in combination with control applications run on mobile devices, e.g., smart phones, can provides for wireless communication to the electrical devices 10, e.g., luminaires, through the adapter structure 50, which allows for configuring the electrical devices to function with PIR occupancy sensors. PIR sensors sense motion, and can be used to detect whether a human has moved in or out of the sensors range. They are often referred to as PIR, “Passive Infrared”, “Pyroelectric”, or “IR motion” sensors. In some examples. PIRs are basically made of a pyroelectric sensor (which you can see below as the round metal can with a rectangular crystal in the center), which can detect levels of infrared radiation. It is noted that in some examples, a 3.5 mm pin PIR sensor 75b (depicted in FIG. 6) may be substituted for the smart sensor, i.e., the 3.5 mm pin bluetooth mesh low voltage sensor and controller. In some examples, a PIR Occupancy Sensor can be employed to support setting delay time and dimming level, in which these settings are configurable through an application run on a mobile computing device, such as a smart phone.

In other examples, the 3.5 mm pin bluetooth mesh low voltage sensor and controller when used in combination with control applications run on mobile devices, e.g., smart phones, can provides for wireless communication to the electrical devices 10, e.g., luminaires, through the adapter structure 50, which allows for configuring the electrical devices to perform daylight harvesting tasks. For example, an ambient daylight sensor allows can be configured for continuous dimming of the luminaires when the areas being illuminated are exposed to natural light.

In some other examples, the 3.5 mm pin bluetooth mesh low voltage sensor and controller when used in combination with control applications run on mobile devices, e.g., smart phones, can provides for wireless communication to the electrical devices 10, e.g., luminaires, through the adapter structure 50, which allows for scene control. For example, the luminaires can be configured with various scenes that can be present for an individual luminaire or group of luminaires using the phone app

In some examples, the wirelessly controlled device system can employ the at least one of the sensor and wireless controller (wireless communication device 75) as a bluetooth mesh device to provide for communication from the electrical device 10 to a user terminal, in which the bluetooth mesh device (connected to the electrical device 10) receiving signal from the user terminal for a command to control at least one of color settings, color correlated temperature settings, ON and OFF control, dimming performance and combinations thereof for light emitted by the electrical device 10. Further, the wirelessly controlled device system can employ the at least one of the sensor and wireless controller (wireless communication device 75) to add new electrical devices 10, e.g., luminaires 10a, 10b, 10c, 10d, to an existing network of luminaires, or remove luminaires from an existing network of luminaires. Further, the wirelessly controlled device system can employ the at least one of the sensor and wireless controller (wireless communication device 75) to add group electrical devices 10, e.g., luminaires 10a, 10b. 10c, 10d, to an existing network of luminaires, or remove luminaires from an existing groups of luminaires. This may include configuring the luminaires in a group to have lighting characteristics consistent with a scene, i.e., setting characteristics of light for a type of lighting for a room or task.

As noted above, the wireless communication device 75 (also referred to as an at least one of a sensor and wireless controller device 75 or wireless controller device 75) interfaces with the electrical device 10, e.g., luminaires, through an adapter 50. The adapter 50 may include an adapter body 52 including an electrical device engagement surface with device electrical interface including a three pin connector 51 for engaging a three pin receptacle 12 of the electrical device 10, and a wireless communication device engagement surface including a pin connector receptacle for receiving the pin connector interface of the wireless communication device 75. The pin connector receptacle 12 is in electrical communication with the three pin connector 51. These features have been described above with reference to FIG. 1.

The structures and systems described with reference to FIGS. 1-6 can be employed in a method of converting an electrical device 10 to a wirelessly controlled device. The electrical device 10 may be a luminaire 10a, 10b, 10c, 10d, as depicted in FIGS. 2-4. The method may include configuring an electrical device 10 comprising at least one light engine comprising light emitting diodes to expose a three pin receptacle 12 through which electrical signal is sent to an electronics driver that is in electrical communication with the at least one light engine. The light engine employs light emitting diodes (LEDs) for a light source. The method may further include engaging an adapter 50 to the electrical device 10. The adapter 50 has been described above with reference to FIG. 1. The adapter 50 includes an adapter body 52 including an electrical device interface including a three pin connector 51 that engages the three pin receptacle 12 of the electrical device 10, and a pin connector receptacle 55 that is in electrical communication with the three pin connector 51. The method may further include engaging a wireless communication device 75 comprising at least one of a controller and a sensor to the adapter 50. The wireless communication device 75 has been described above with reference to FIGS. 1 and 5-6. Further, the wireless communication device 75 is also referred to as an at least one of a sensor and wireless controller device 75 or wireless controller device 75. The wireless communication device 75 including a pin connector interface 75 for transmitting at least one of data and control signals that engages the pin connector receptacle 55 of the adapter 50.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of an ADAPTER FOR CONNECTING WIRELESS CONTROLS AND SENSORS TO ELECTRIC DEVICES (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. An adapter structure comprising:
an adapter body including an electrical device engagement surface with a first engagement feature for engagement of the adapter body to an electrical device and an adapter engagement surface with a second engagement feature for engagement of at least one of a sensor and wireless controller device to the adapter body;
a device electrical interface positioned on the electrical device engagement surface, the device electrical interface including a three pin connector for engaging a three pin receptacle of an electrical device; and
an adapter electrical interface positioned on the adapter engagement surface, the adapter electrical interface includes a pin connector receptacle for receiving a pin from at least one of the sensor and wireless controller, wherein the pin connector receptacle is in electrical communication with the three pin connector.

2. The adapter structure of claim 1, wherein the first engagement feature is a male threaded structure for engagement of a female threaded structure of the electrical device, wherein a screw thread of the male threaded structure engages an internal thread of the female threaded structure for the electrical device.

3. The adapter structure of claim 1, wherein the first engagement feature includes a deformable tab having a retaining edge for reversible engagement into the a slot of the electrical device.

4. The adapter structure of claim 1, wherein the second engagement feature is a female threaded structure for engagement of a male threaded structure of the sensor, wherein an internal thread of the female threaded structure engages a screw thread of the male threaded structure for the at least one of the sensor and wireless controller.

5. The adapter structure of claim 1, wherein the three pin connector comprises pogo pins.

6. The adapter structure of claim 5, wherein individual pogo pins for the three pin connector are spaced to engage a target that provides the three pin receptacle of the electrical device.

7. The adapter structure of claim 6, wherein the target has a geometry of a circle for each pogo pin, wherein the pins contact the geometry of the circle for the target as the adapter body is engaged to the device by rotating the adapter body relative to the device to thread the male threaded male engagement structure for the adapter body to female threaded structure of the electrical device.

8. The adapter structure of claim 1, wherein the electrical device is a luminaire.

9. The adapter structure of claim 1, wherein the at least one of the sensor and wireless controller is a bluetooth mesh device.

10. The adapter structure of claim 9, wherein the at least one of the sensor and wireless controller is a bluetooth mesh device provides for communication from the electrical device to a user terminal, the bluetooth mesh device receiving signal from the user terminal for a command to control at least one of color settings, color correlated temperature settings, ON and OFF control, dimming performance and combinations thereof for light emitted by the electrical device.

11. The adapter structure of claim 1, wherein pin connector receptacle is in electrical communication with the three pin receptacle through at least one electrically conductive structure that extends from the device electrical interface positioned on the electrical device engagement surface to the adapter electrical interface positioned on the adapter engagement surface through the adapter body.

12. A wirelessly controlled device system comprising:
an electrical device comprising at least one light engine comprising light emitting diodes, the at least one light engine powered by an electronics driver in electrical communication with a three pin receptacle through which electrical signal to the electronics driver is communicated;
a wireless communication device comprising at least one of a controller and a sensor, the wireless communication device including a pin connector interface for transmitting at least one of data and control signals; and
an adapter comprising an adapter body including an electrical device engagement surface with device electrical interface including a three pin connector for engaging a three pin receptacle of the electrical device, and a wireless communication device engagement surface including a pin connector receptacle for receiving the pin connector interface of the wireless communication device, wherein the pin connector receptacle is in electrical communication with the three pin connector.

13. The wirelessly controlled device system of claim 12, wherein the electrical device is a luminaire.

14. The wirelessly controlled device system of claim 13, wherein the luminaire has a form factor of a high bay light.

15. The wirelessly controlled device system of claim 13, wherein the luminaire is a fixture for a high intensity discharge replacement lamp including a light emitting diode light source.

16. The wirelessly controlled device system of claim 12, wherein the at least one of the sensor and wireless controller is a bluetooth mesh device.

17. The wirelessly controlled device system of claim 12, wherein the at least one of the sensor and wireless controller is a bluetooth mesh device provides for communication from the electrical device to a user terminal, the bluetooth mesh device receiving signal from the user terminal for a command to control at least one of color settings, color correlated temperature settings, ON and OFF control, dimming performance and combinations thereof for light emitted by the electrical device.

18. The wirelessly controlled device system of claim 17, wherein the user terminal is a wall light switch.

19. The wirelessly controlled device system of claim 17, wherein the user terminal is a computing device selected from the group consisting of a smart phone, table computer, laptop computer, desktop computer, computing terminal and combinations thereof.

20. A method of converting an electrical device to a wirelessly controlled device comprising:
configuring an electrical device comprising at least one light engine comprising light emitting diodes to expose a three pin receptacle through which electrical signal is sent to an electronics driver that is in electrical communication with the at least one light engine;
engaging an adapter to the electrical device, the adapter comprising an adapter body including an electrical device interface including a three pin connector that engages the three pin receptacle of the electrical device, and a pin connector receptacle that is in electrical communication with the three pin connector; and
engaging a wireless communication device comprising at least one of a controller and a sensor to the adapter, the wireless communication device including a pin connector interface for transmitting at least one of data and control signals that engages the pin connector receptacle of the adapter.
